(19) United States
(12) Patent Application Publication
(10) Pub. No.: US 2023/0153493 A1
(43) Pub. Date: May 18, 2023

(54) SYSTEMS AND METHODS FOR CREATING PATTERNS ON GARMENTS

(71) Applicants: Kyle Stephens, Los Angeles, CA (US); Jack Payne, Brooklyn, NY (US); Aydin Palabiyikoglu, Rancho Cucamonga, CA (US)

(72) Inventors: Kyle Stephens, Los Angeles, CA (US); Jack Payne, Brooklyn, NY (US); Aydin Palabiyikoglu, Rancho Cucamonga, CA (US)

(21) Appl. No.: 17/987,830

(22) Filed: Nov. 15, 2022

Related U.S. Application Data
(60) Provisional application No. 63/279,601, filed on Nov. 15, 2021.

(51) Int. Cl. G06F 30/27; G06F 30/12

(52) U.S. Cl. CPC G06F 30/27; G06F 30/12; G06F 2113/12

(57) ABSTRACT

There are disclosed systems for creating patterns on garments including a memory storing an executable logic, a processor executing the executable logic to receive a non-computer-generated input, receive a non-computer-generated garment design information, learn a relationship between the designer input and the non-computer-generated garment design information, generate a garment wear pattern based on the design model and a designer input, determine, using the design model, that the generated garment wear pattern is one of a computer-generated wear pattern and a non-computer-generated wear pattern, adjust a network weight of a relationship between the non-computer-generated input and the based on the non-computer-generated garment design information to produce a more realistic wear pattern, receive a designer input, generate a garment wear pattern based on the design model and the designer input, and transmit the generated garment wear pattern for application to a garment.

### CROSS-REFERENCE TO RELATED APPLICATIONS

The present claims the benefit of U.S. Provisional Patent Application No. 63/279,601 entitled “SYSTEMS AND METHODS FOR CREATING PATTERNS ON GARMENTS”, filed on Nov. 15, 2021. The entire contents of the above-listed application are hereby incorporated by reference for all purposes.

### BACKGROUND

For apparel products, specifically denim, a distressed finish adds a vintage or worn in style. A distressed finish, however, requires extracting a wear pattern from an existing garment, that has been naturally distressed, and finishing the new apparel with a laser. As a result, apparel designers need a library of distressed garments with the right aesthetic. More efficient ways to create realistic wear patterns or to iterate from a wear pattern sketch are highly desirable by designers. Such tools would give designers more control, be more efficient and provide new options.

### SUMMARY

The present disclosure is directed to systems and methods for creating patterns on garments, substantially as shown in and/or described in connection with at least one of the figures, as set forth more completely in the claims.

The system for creating patterns on garments includes a memory storing an executable logic, a processor executing the executable logic to train a design model on a relationship between non-computer-generated garment design information and non-computer-generated garment wear patterns, receive a designer input, generate a garment wear pattern based on the design model and the designer input, and save the generated garment wear pattern to the memory.

In some implementations, the system may train a design model on a relationship between non-computer-generated garment design information and non-computer-generated images of garments with wear patterns.

In some implementations, the system may generate an image of a garment with a wear pattern based on the design model and the designer input and save the image to the memory.

In some implementations, the generated image contains the garment wear pattern only, wherein the garment wear pattern can be applied to a physical garment.

In some implementations, the system may transmit the generated garment wear pattern for application to a garment.

In some implementations, the system further comprises a distressing machine for applying the generated garment wear pattern to a garment.

In some implementations, the distressing machine includes at least one of a laser, an acid washing machine, a sand blasting machine, an enzyme washing machine, a water-jet fading machine, a sunlight fading machine, an over dye tinting machine, and an ozone fading machine.

In some implementations, to train the design model, the processor executes a training code to receive a non-computer-generated input, receive a non-computer-generated garment design information, learn a relationship between the designer input and the non-computer-generated garment design information, generate a garment wear pattern based on the design model and a designer input, determine, using the design model, that the generated garment wear pattern is one of a computer-generated wear pattern and a non-computer-generated wear pattern, and adjust a network weight of a relationship between the non-computer-generated input and the non-computer-generated garment design information to produce a more realistic wear pattern.

In some implementations, the designer input is a line drawing of a garment.

In some implementations, the executable logic comprises an artificial neural network.

In some implementations, the designer input comprises a design element overlayed on a region of the garment wear pattern.

In some implementations, the design model is based on a generative adversarial network of a plurality of non-computer-generated wear patterns.

There is disclosed a method for execution by a system having a hardware processor, the method comprising training, using the hardware processor, a design model on a relationship between non-computer-generated garment design information and non-computer-generated garment wear patterns, receiving, using the hardware processor, a designer input, generating, using the hardware processor, a garment wear pattern based on the design model and the designer input, and transmitting, using the hardware processor, the generated garment wear pattern for application to a garment.

In some implementations, the method further comprises applying the generated garment wear pattern to a garment using a distressing machine.

In some implementations, wherein, to train the design model, method further comprises receiving, using the hardware processor, a non-computer-generated input, receiving, using the hardware processor, a non-computer-generated garment design information, learning, using the hardware processor, a relationship between the designer input and the non-computer-generated garment design information, generating, using the hardware processor, a garment wear pattern based on the design model and a designer input, determine, using the design model, that the generated garment wear pattern is one of a computer-generated wear pattern and a non-computer-generated wear pattern, and adjusting, using the hardware processor, a network weight of a relationship between the non-computer-generated input and the based on the non-computer-generated garment design information to produce a more realistic wear pattern.

In some implementations of the method, the designer input is a line drawing of a garment.

In some implementations of the method, the design model comprises an artificial neural network.

In some implementations of the method, the designer input comprises a design element overlayed on a region of the garment wear pattern.

In some implementations of the method, the design model is based on a generative adversarial network of a plurality of non-computer-generated wear patterns.

There is disclosed a system, comprising a user device with a processing device configured to generate a wear pattern for a garment, where in the user device comprises a memory device configured to store a first non-computer-generated wear pattern that utilize reorientations of a first garment with a wear pattern, and store a second computer-generated wear pattern that comprise a second garment with stylized distress pattern comprising a style element, and the processing device configured to execute a generative model that integrates the first non-computer-generated wear pattern or the second non-computer-generated wear pattern to create a computer-generated wear pattern, a server configured to execute an artificial neural network program generated from an analysis of a database of distressed garments, wherein the artificial neural network program is trained to identify, from the first non-computer-generated wear pattern or the second non-computer-generated wear pattern, elements of a distressed garment, and the artificial neural network program is configured to generate a machine-readable algorithm based on a prioritization of the distressed garment.

In some implementations, the generative model produces a distressing file for a distressing machine.

In some implementations, the non-computer-generated wear pattern is a text description of a portion of the garment.

### BRIEF DESCRIPTION OF THE DRAWINGS

The present description will be understood more fully when viewed in conjunction with the accompanying drawings of various examples of systems and methods for creating patterns on garments. The description is not meant to limit systems and methods for creating patterns on garments to the specific examples. Rather, the specific examples depicted and described are provided for explanation and understanding of systems and methods for creating patterns on garments. Throughout the description the drawings may be referred to as drawings, figures, and/or Fig.

FIG. 1 shows a diagram of an exemplary system for creating patterns on garments, according to an implementation of the present disclosure;

FIG. 2 shows a diagram depicting various devices used in the system depicted in FIG. 1;

FIG. 3 shows a flow diagram of an exemplary method for training a system for creating patterns on garments, according to an implementation of the present disclosure;

FIG. 4 shows a flow diagram of an exemplary method for creating patterns on garments, according to an implementation of the present disclosure;

FIG. 5A shows examples of synthesized photorealistic images;

FIG. 5B shows examples of synthesized photorealistic images;

FIG. 6 shows a diagram of an exemplary system for creating patterns on garments, according to an implementation of the present disclosure;

FIG. 7 shows a diagram of an exemplary system for creating patterns on garments, according to an implementation of the present disclosure;

FIG. 8 shows a diagram of an exemplary system for creating patterns on garments, according to an implementation of the present disclosure;

FIG. 9 shows a diagram of an exemplary system for creating patterns on garments, according to an implementation of the present disclosure;

FIG. 10 shows a diagram of an exemplary system for creating patterns on garments, according to an implementation of the present disclosure;

FIG. 11 illustrates an artificial neural network (ANN) 700, according to an implementation of the present disclosure;

FIG. 12 illustrates neural network 800, according to an implementation of the present disclosure;

FIG. 13 illustrates a method of training a machine learning model of a machine learning module, according to an implementation of the present disclosure; and

FIG. 14 illustrates a method of analyzing input data using a machine learning module, according to an implementation of the present disclosure.

### DETAILED DESCRIPTION

Systems and methods for creating patterns on garments as disclosed herein will become better understood through a review of the following detailed description in conjunction with the figures. The detailed description and figures provide merely examples of the various embodiments of systems and methods for creating patterns on garments. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

When designing and manufacturing apparel, particularly denim, it is often desired to finish the apparel in a way that gives it a worn-in, vintage, or distressed appearance prior to sale. This is often accomplished by extracting the wear pattern from an existing distressed/vintage garment and applying this wear pattern to new garments—often by finishing with a laser—so that the new garments have the same distressed appearance as the existing garment after finishing. Apparel designers spend a lot of time searching for and acquiring distressed garments that have a desirable aesthetic, and apparel manufacturers spend a lot of time extracting wear patterns from distressed garments provided by designers

Implementations of systems and methods for creating patterns on garments may address some or all of the problems described above, and such implementations by providing a system and method to automatically generate images of distressed garments that may be computer-generated (synthetic), look photorealistic, may be novel (i.e., don't correspond to any existing garment), and/or may be guided by input from the designer such as a rudimentary sketch, a labeled sketch, a text description, an inspirational reference garment, or some combination of these.

Implementations of systems and methods for creating patterns on garments may reduce spending time extracting wear patterns from distressed garments by hand, apparel manufacturers could use the system of the present disclosure to automatically translate wear patterns from images of distressed garments (either real or synthetic) into laser files that can mimic the wear patterns via laser finishing. In some implementations, disclosed methods for creating patterns on garments may be performed on one computing device. In other implementations, disclosed methods for creating patterns on garments may be distributed across multiple devices. As used here, a non-computer generated wear pattern may be a user input or a designer input.

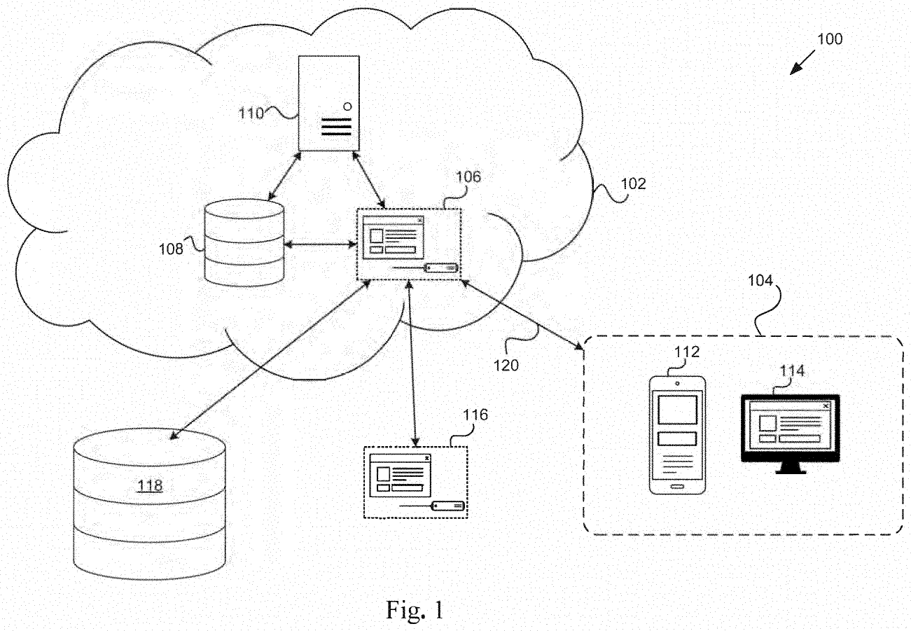

FIG. 1 illustrates a system 100 for creating patterns on a garment 100, according to an implementation of the present disclosure. The system 100 includes internal and external data resources for managing a project. The system 100 may result in reduced memory allocation at client devices and may conserve memory resources for application servers.

The system 100 may include a cloud-based data management system 102 and a user device 104. The cloud-based data management system 102 may include an application server 106, a database 108, and a data server 110. User device 104 may be a computing system for use in creating patterns on garments. User device 104 may include one or more devices associated with user profiles of the system 100, such as a smartphone 112 and/or a personal computer 114. The system 100 may include external resources such as an external application server 116 and/or an external database 118. The various elements of the system 100 may communicate via various communication links 120. An external resource may generally be considered a data resource owned and/or operated by an entity other than an entity that utilizes the cloud-based data management system 102 and/or the user device 104.

The system 100 may be web-based. The user device 104 may access the cloud-based data management system 102 via an online portal set up and/or managed by the application server 106. The system 100 may be implemented using a public internet. The system 100 may be implemented using a private intranet. Elements of the system 100, such as the database 108 and/or the data server 110, may be physically housed at a location remote from an entity that owns and/or operates the system 100. For example, various elements of the system 100 may be physically housed at a public service provider such as a web services provider. Elements of the system 100 may be physically housed at a private location, such as at a location occupied by the entity that owns and/or operates the system 100.

The communication links 120 may be direct or indirect. A direct link may include a link between two devices where information is communicated from one device to the other without passing through an intermediary. For example, the direct link may include a Bluetooth® connection, a Zigbee® connection, a Wifi Direct® connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

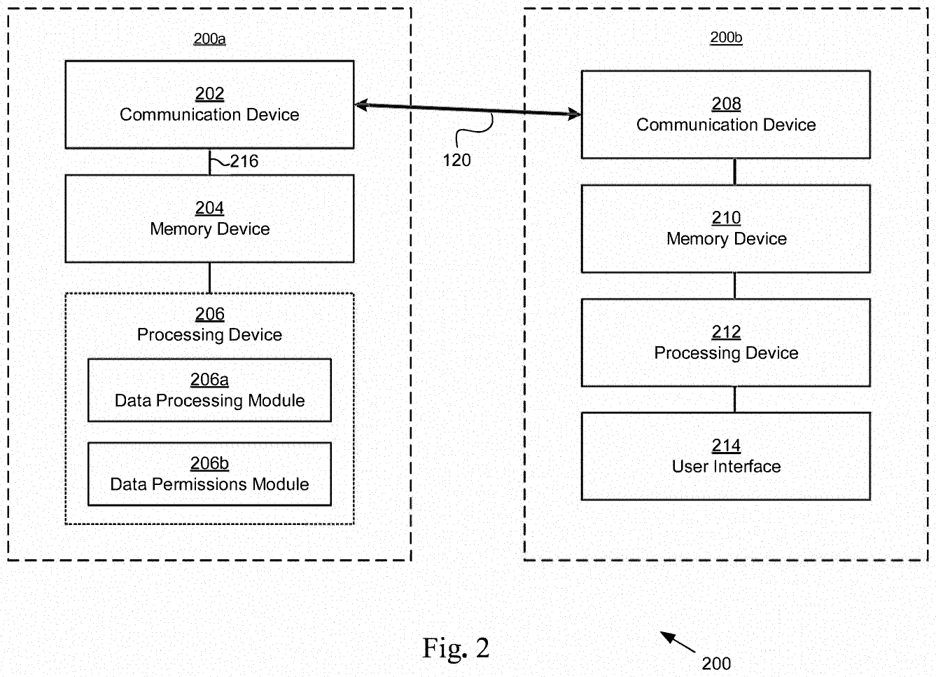

FIG. 2 illustrates a device schematic 200 for various devices used in the system 100, according to an implementation of the present disclosure. A server device 200a may moderate data communicated to a client device 200b based on data permissions to minimize memory resource allocation at the client device 200b.

The server device 200a may include a communication device 202, a memory device 204, and a processing device 206. In some implementations, memory device 204 may be a non-transitory memory device for storing computer code and executable logic. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may retrieve data stored in the memory device 204 and output the data to the client device 200a via the communication device 202. The data permissions module 206b may determine, based on permissions data stored in the memory device, what data to output to the client device 200b and what format to output the data in (e.g., as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth. In some implementations, memory device 210 may be a non-transitory memory device for storing computer code and executable logic.

As stated above, the server device 200a and the client device 200b may be representative of various devices of the system 100. Various of the elements of the system 100 may include data storage and/or processing capabilities. Such capabilities may be rendered by various electronics for processing and/or storing electronic signals. One or more of the devices in the system 100 may include a processing device. For example, the cloud-based data management system 102, the user device 104, the smartphone 112, the personal computer 114, the external application server 116, and/or the external database 118 may include a processing device. One or more of the devices in the system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the system 100. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device. In some implementations, the processing device may be a hardware processor.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device. In some implementations, the memory device may be a non-transitory memory.

Various of the devices in the system 100 may include data communication capabilities. Such capabilities may be rendered by various electronics for transmitting and/or receiving electronic and/or electromagnetic signals. One or more of the devices in the system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may receive and transmit the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth® programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the system 100.

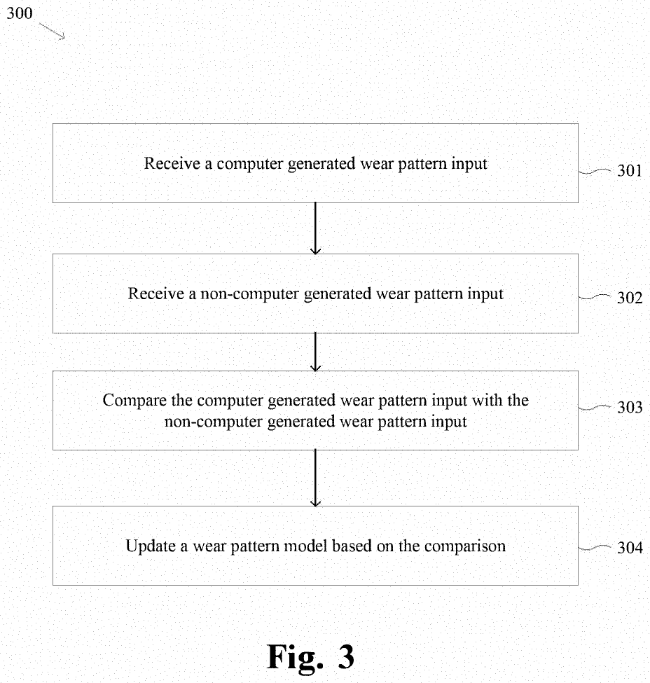

FIG. 3 shows a flow diagram of an exemplary method for training a system for creating patterns on garments, according to an implementation of the present disclosure. Method 300 begins at 301 when processing device 206 receives a computer-generated wear pattern. In some implementations, system 100 may analyze characteristics of a computer-generated wear pattern. An executable logic of system 100 may create a score for the computer-generated wear pattern, the score associated with a confidence that the computer-generated wear pattern is a computer-generated product. In some implementations, the executable logic of system 100 may update a computer-generated model based on the analysis of the computer-generated wear pattern and the confidence score.

At 302, processing device 206 receives a non-computer-generated wear pattern. In some implementations, system 100 may analyze characteristics of the non-computer-generated wear pattern. The executable logic of system 100 may create a score for the non-computer-generated wear pattern, the score associated with a confidence that the non-computer-generated wear pattern is a computer-generated product. In some implementations, the executable logic of system 100 may update a computer-generated model based on the analysis of the non-computer-generated wear pattern and based on the confidence score.

At 303, processing device 206 compares a computer-generated textile with the non-computer-generated wear pattern. In some implementations, comparison of the computer-generated wear pattern with the non-computer-generated wear pattern may include analysis of various characteristics of each wear pattern. In some implementations, system 100 may use an iterative approach to train the executable logic of system 100 to create natural-looking wear patterns.

In parallel, and not in communication with the portion of the executable logic that is analyzing whether the input designs are computer-generated, the executable logic of system 100 may generate new wear pattern designs. The executable logic of system 100 may analyze an input wear pattern to determine if it is a computer-generated wear pattern. Based on a number or training inputs and a number of iterations, the executable logic of system 100 may learn to identify wear patterns that are computer generated. Similarly, the executable logic of system 100 may use the same iterative training approach to improve the accuracy of identifying non-computer-generated wear patterns. The executable logic of system 100 may increase the realistic, non-computer-generated appearance of each subsequent new wear pattern design generated based on the iterative nature of the analysis-update-generate cycle of system 100.

At 304, processing device 206 updates a computer-generated wear pattern based on the comparison of the computer-generated textile and the non-computer-generated wear pattern. In some implementations, method 300 may be repeated to train system 100 using an iterative training process. In some implementations, the training process may be an adversarial training process to improve the quality of computer-generated designs. Method 300 may be a discriminator side of the executable logic of system 100 trained to discern computer-generated pattern from non-computer-generated patterns to create computer-generated patterns that have the characteristics of non-computer-generated patterns. A generator side of the executable logic of system 100 may generate patterns based on the training of the discriminator side.

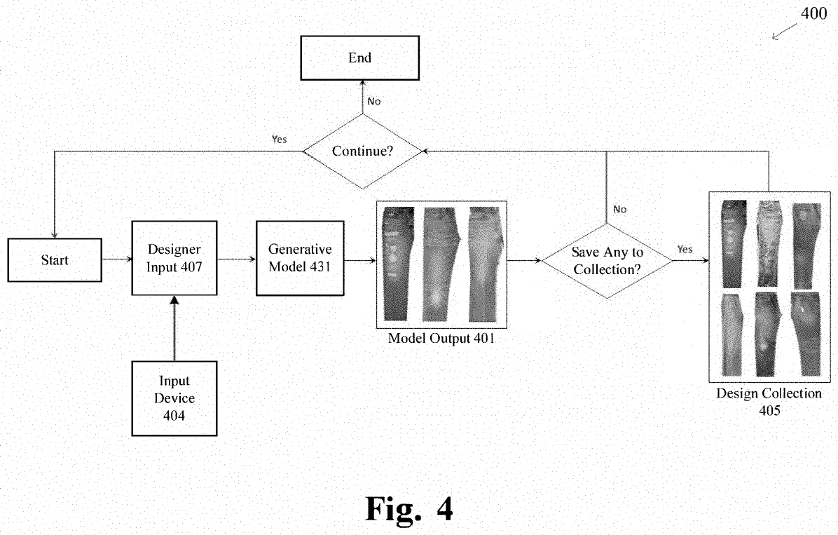

FIG. 4 shows a diagram of an exemplary method for creating patterns on garments, according to one of the embodiments of the present disclosure. Method 400 may be executed processing device 206 or processing device 212 of system 100. In some implementations, wear pattern 401 may be a wear pattern corresponding to a garment that was generated by a computer. Wear pattern 401 may include wear pattern elements such as a location of the wear pattern on the garment, one or more shapes of the wear pattern, and a distress factor of the wear pattern. In some implementations, the wear pattern may include one or more shapes corresponding to the natural wear patterns developed on garments worn for a period of time. The wear patterns for various garments may be garment specific. For example, there may be wear patterns for t-shirts, dress shirts, shorts, pants, jeans, and other garments. In some implementations, wear pattern 401 may be a digital pattern for applying to a garment. In other embodiments, wear pattern 401 may be a photograph of a garment displaying a computer-generated wear pattern. In other embodiments, wear pattern 401 may include a library of computer-generated wear patterns.

Designer input 407 may be a non-computer-generated garment information received from a user. In some implementations, designer input 407 may be digital file including a wear pattern for a garment that was created by an artist, designer, or other individual. Designer input 407 may be an artist created wear pattern created by an artist using a design program on a computer. In some implementations, designer input 407 may be a photograph of a garment displaying a non-computer-generated wear pattern, such as a natural wear pattern. A natural wear pattern may include patterning developed on a garment worn by an individual for a period of time, such as a number of days, a number of weeks, or a number of years. In some implementations, designer input 407 may be a library of images depicting a plurality of garments each displaying a natural wear pattern or a non-computer-generated wear pattern. In other implementations, designer input 407 may include a library of files including a plurality of artist created digital wear patterns. Designer input 407 may include line sketches, labelled sketches, text descriptions, reference garments, edited reference garments, such as masked reference garments or local patch edited garments. In some implementations, designer input 407 may be received from a user via input device 404.

In some implementations, method 400 may be executed by user device 104. User device 104, using a hardware processor executing an executable logic, may use generative model 331 to produce wear pattern 401 based on the designer input 407. The designer input 407 can include a variety of sources from photographs to sketches to text description. The designer input 407 may include masked or patched images of reference garments. The images may be synthesized using generative model 431. In some implementations, generative model 431 has been trained on a database of images of existing distressed garments.

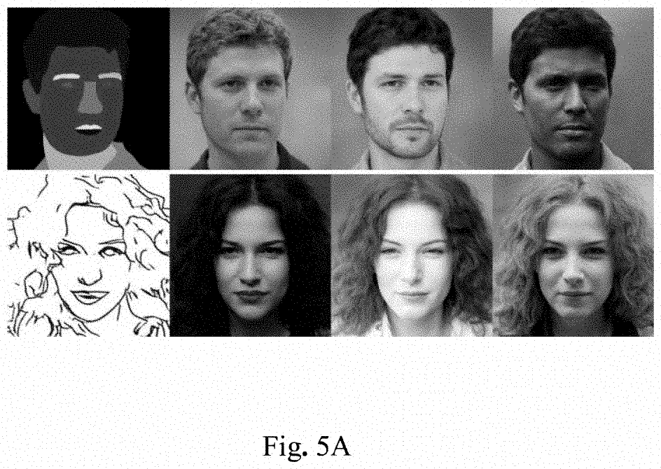

FIG. 5A and FIG. 5B show examples of synthesized photorealistic images. The current state-of-the-art for photorealistic image synthesis is a model called styleGAN (Karras et al., 2019, 2020, incorporated in its entirety herein by reference) which has been used to synthesize photorealistic images of faces, cars and bedrooms (see FIGS. 5A and 5B).¹ FIG. 5A shows sample inputs for a sketch (bottom left) and labeled sketch (top left). The photorealistic images in the right three columns show corresponding diverse outputs generated by the pSp model, using a styleGAN Generator trained on 30,000 real face images (CelebA-HQ dataset) with corresponding sketch and labeled sketch images encoded in the latent space of the styleGAN Generator (Note that the training sketches were generated algorithmically from the training faces and, although they look sketch-like, are not human-drawn). For instance, after training with 70,000 high resolution (1024×1024) images of faces (the FFHQ database), the styleGAN generator was able to synthesize the random faces images shown in FIG. 5A. These images are entirely artificial (and not curated)—they don't correspond to any actual faces from the training data—and yet look highly realistic. FIG. 5B shows similar results after training with images of bedrooms and cars, showing the flexibility of the model. FIG. 5B shows photorealistic computer-generated bedrooms (left) and cars (right), synthesized using the styleGAN Generator after training with 100,000+ low-resolution images of real bedrooms and cars (drawn from the LSUN database). Karras, T., Laine, S., & Aila, T. (2019). A style-based generator architecture for generative adversarial networks. ArXiv:1812.04948 [Cs, Stat]. http://arxiv.org/abs/1812.04948; Karras, T., Laine, S., Aittala, M., Hellsten, J., Lehtinen, J., & Aila, T. (2020). Analyzing and improving the image quality of styleGAN. ArXiv: 1912.04958 [Cs, Eess, Stat]. http://arxiv.org/abs/1912.04958

Thus, with a suitable database of high-quality images of distressed garments—which any denim brand or denim laundry would have access to—styleGAN could likewise be trained to generate highly realistic images of novel distressed garments. The images will again be synthesized using a generative model 331 that has been trained on a database of images of existing distressed garments, with styleGAN as the current state-of-the-art for photorealistic image synthesis. Once styleGAN is trained, its Generator uses an internal latent space with multiple layers to represent images before synthesis. Thus, styleGAN can be made to receive conditional input by separately training encoders that map inputs (such as sketches or text) into the styleGAN latent space. The current state-of-the-art for encoding line sketches, label sketches, and other image types into the styleGAN latent space is an image-to-image translation model known as pixel2style2pixel or pSp (Richardson et al., 2021, incorporated in its entirety herein by reference). The current state-of-the-art for encoding text into the styleGAN latent space is a model known as Text-guided diverse image generation and manipulation via GAN or TediGAN (Xia et al., 2021a,b, incorporated in its entirety herein by reference).² ²Xia, W., Yang, Y., Xue, J.-H., & Wu, B. (2021a). TediGAN: Text-guided diverse face image generation and manipulation. ArXiv: 2012.03308 [Cs]. http://arxiv.org/abs/2012.03308; Xia, W., Yang, Y., Xue, J.-H., & Wu, B. (2021b). Towards open-world text-guided face image generation and manipulation. ArXiv: 2104.08910 [Cs]. http://arxiv.org/abs/2104.08910

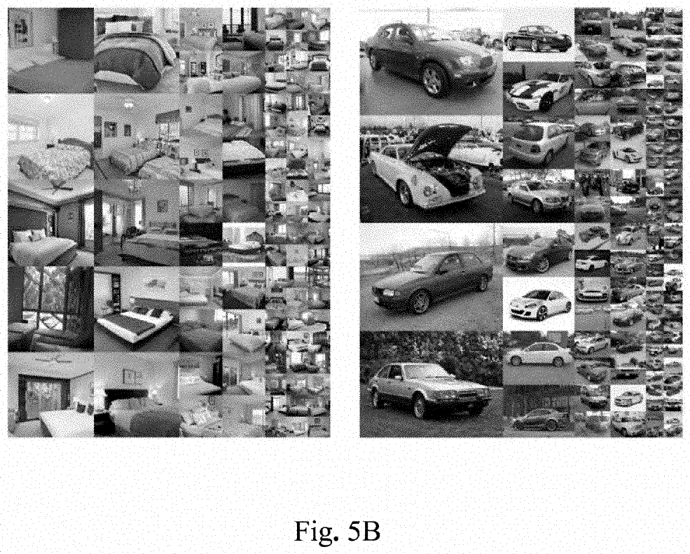

FIG. 6 shows a diagram of an exemplary system for creating patterns on garments, according to an implementation of the present disclosure. In some implementations, garment logic 390 may engage the user device 104 to analyze a wear pattern to determine if it is a computer-generated wear pattern 301 or not 303. User device 104 may interact with garment logic 390 locally or using a remote connection, such as accessing garment logic 390 using cloud-based data management system 102. Based on a number or training inputs and a number of iterations, The garment logic 390 engages the user device 104 possibly in conjunction with a cloud-based data management system 102 may learn to identify wear patterns that are computer generated 301. Similarly, the garment logic 390 engages the user device 104 possibly in conjunction with a cloud-based data management system 102 may use the same iterative training approach to improve the accuracy of identifying non-computer-generated wear patterns 303. The user can repeat 315 the process as many times as desired to produce adequate computer-generated wear patterns 301. After the discriminator side of executable garment design logic 390 has been trained, the generator side of garment design logic 390 may engage the user device 104. In some implementations, system 100 may include cloud-based data management system 102 to generate new computer-generated wear patterns 301.

Wear pattern generative model 331 may be a digital model for creating wear patterns generated on a computing device, such as user device 104, and stored in a non-transitory memory in a machine-readable format. In some implementations, wear pattern generative model 331 may be a design including instructions for an automated system to create a natural-looking wear pattern on a garment. In some implementations, wear pattern generative model 331 may include instructions for a distressing machine to implement a natural-looking wear pattern on a garment using laser engraving, acid washing, sand blasting, enzyme washing, water-jet fading, sunlight fading, over dye tinting, ozone fading, or other distressing methods used to make garments appear distressed from natural wearing.

In some implementations, wear pattern generative model 331 may include different wear patterns for different garments. For example, wear pattern generative model 331 may include a particular pattern corresponding to a particular design of jeans, a different wear pattern corresponding to a particular design of denim skirt, a different wear pattern corresponding to a design of shirt, etc. Wear pattern generative model 331 may include a plurality of patterns each corresponding to a different design of jeans. In some implementations, wear pattern generative model 331 may include a plurality of iterations of a wear pattern scaled to correspond to different sizes of a particular design of a garment, such as different sizes of jeans.

Wear pattern generative model 331 may include information corresponding to a distress factor of a particular design. The distress factor may include a measure of how distressed a particular garment will appear when treated with wear pattern generative model 331. In some implementations, the distress factor may include information or instructions affecting the color of a garment. In other embodiments, the distress factor may include a degree to which the fabric of the garment should be worn or damaged. When wear pattern generative model 331 includes a lower distress factor, the fabric of the garment may be processed less, and a higher distress factor may result in a garment that is treated to processed more.

Generative model 331 can generate multiple computer-generated wear patterns 301 such that a user may wish to compile 312 computer generated wear patterns 301 into a design collection 305. Design collections enable classifications of computer-generated wear patterns 301 into curated collections, such as design connection 405, where the wear patterns 301 are collected so as to facilitate the production of distressed garments. The designer can then choose which, if any, garment images they like and can add 313 them to a design collection 305. If the designer does not like any of the garment images, they can either run the synthesis again 314 to get a new set of garment images that are still consistent with the input—since the generative model is stochastic, it will produce different results even with the same inputs—or they can supply different input.

An embodiment of the system 100 includes a user device 104 where the garment processing logic 390 may include artificial intelligence code to learn from various inputs, such as the designer input 307, and modify its wear-pattern-creation logic based on one or more training sets. Garment processing logic 390 may include steps used for adding features to garments. Garment processing logic 390 may be used to add wear patterns 301 to garments, textiles, or articles of clothing by laser engraving, acid washing, sand blasting, enzyme washing, water jet fading, sunlight fading, over dye tinting, ozone fading, or other methods used to make garments appear distressed from natural wearing. Each form of wear pattern is saved as a series of machine-readable instructions able to execute said wear pattern generative model 331 in the production process.

That machine readable process, in an embodiment, constitutes a distressing file. Ordinarily, designers extract wear patterns from photographs of distressed garments via manual editing with software such as Adobe Photoshop. Because this process requires skill and training for adequate results and is generally time consuming, it would be desirable if they could automatically extract wear patterns for laser finishing from images of distressed garments. In another implementation, apparel companies or manufacturers will input an image of a distressed garment to an Image-to-Image Translation model that will then synthesize a grayscale image that can be used with a laser machine to mimic the wear pattern elements of the distressed garment. The wear pattern generative model 331 serves to create computer generated wear patterns 301 that expedite the creation of the distressing file.

FIG. 6 shows a flowchart illustrating an embodiment method for creating patterns on garments 100. The method for creating patterns on garments 100, operating on a user device 104, involves garment processing logic 390. The garment processing logic 390 uses a designer input 307 of line wear patterns 306. Wherein designer input can come from a variety of sources, in this embodiment, designer input is limited to line wear patterns 306. As a result, the wear pattern generative model 331 then creates computer generated wear patterns 301 based on the line drawing. The wear patterns that naturally appear on garments include a variety of shapes, patterns, and colors. In some implementations, wear pattern generative model 331 may include shapes, patterns, and colors the imitate those caused by natural wearing of garments.

As shown in FIG. 6, generative model 331 generates multiple computer-generated wear pattern options 301 that each match the patten of distressing indicated on designer input shown by line drawing 306. In some implementations, the wear pattern options 301 vary in color and intensity of abrasion, but the placements and shapes of the wear pattern are determined by the line drawing 306. In some implementations, generative model 331 may have already been trained to receive conditional input, e.g., line drawings. In some implementations, generative model 331 may have already been trained twice, once on a database of images of distressed garments, and once on a database linking line drawings to images of distressed garments.

At 307, the garment processing logic 390 receives the line wear patterns 306. In some implementations, the system 100 may analyze characteristics of the designer input 307. In the present embodiment, the designer input takes the form of a line wear pattern 306. The user device 104 may create a score for computer generated wear patterns 301, the score associated with a confidence that the computer generated wear patterns are authentic and do not appear to be computer-generated. In some implementations, user device 104 may update the generative model 331 based on the based on the confidence score. In some embodiments, the score can be generated by a cloud-based data management system 102.

Additionally, in an embodiment, the design input 307 can incorporate multiple forms of designer input 307 in order to integrate images, line drawings and text descriptions to create multi-parameter computer generated images 301.

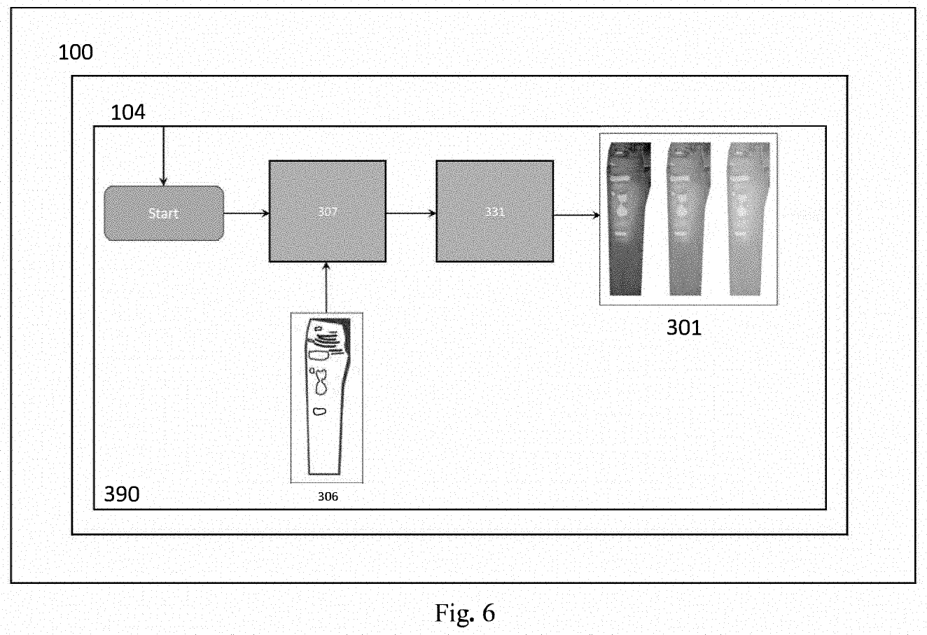

FIG. 7 shows a flowchart illustrating an embodiment method for creating patterns on garments 100. The method for creating patterns on garments 100, operating on a user device 104, involves garment processing logic 390. The garment processing logic 390 uses a designer input 307 of text descriptions of wear patterns 308. Wherein designer input 307 can come from a variety of sources, in this embodiment, designer input 307, is limited to text descriptions of wear patterns 308. As a result, the wear pattern generative model 331 then creates computer generated wear patterns 301.

At 307, the garment processing logic 390 receives the text descriptions of wear patterns 308. In some implementations, the system 100 may analyze characteristics of computer generated wear patterns 301. The user device 104 creates a score for computer-generated wear pattern 301, the score associated with a confidence that the computer-generated wear patterns 301 are authentic and not computer-generated. In some implementations, user device 104 may update the generative model 331 model based on the analysis of computer-generated wear patterns 301 and based on the confidence score. In some embodiments, the score can be generated by a cloud-based data management system 102.

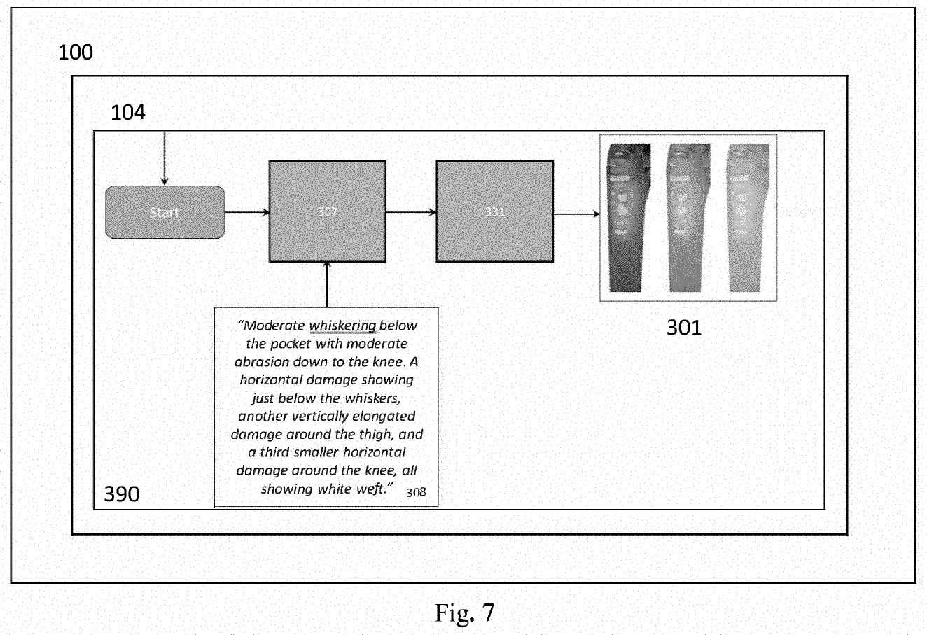

FIG. 8 shows a flowchart illustrating an embodiment method for creating patterns on garments 100. The method for creating patterns on garments 100, operating on a user device 104, involves garment processing logic 390. The garment processing logic 390 uses a designer input 307 of labeled sketches 362. Wherein designer input 307 can come from a variety of sources, in this embodiment, designer input 307 , is limited to labeled sketches 362. As a result, the wear pattern generative model 331 then creates computer generated wear patterns 301 based on the color-coded wear pattern design elements 362.

At 307, the garment processing logic 390 receives labeled sketches of wear patterns 362. In some implementations, the system 100 may analyze characteristics computer generated wear patterns 301. The user device 104 creates a score for computer-generated wear pattern 301, the score associated with a confidence that computer-generated wear patterns 301 are authentic and not computer-generated. In some implementations, user device 104 may update the generative model 331 based on the analysis of computer-generated wear patterns 301 and based on the confidence score. In some embodiments, the score can be generated by a cloud-based data management system 102.

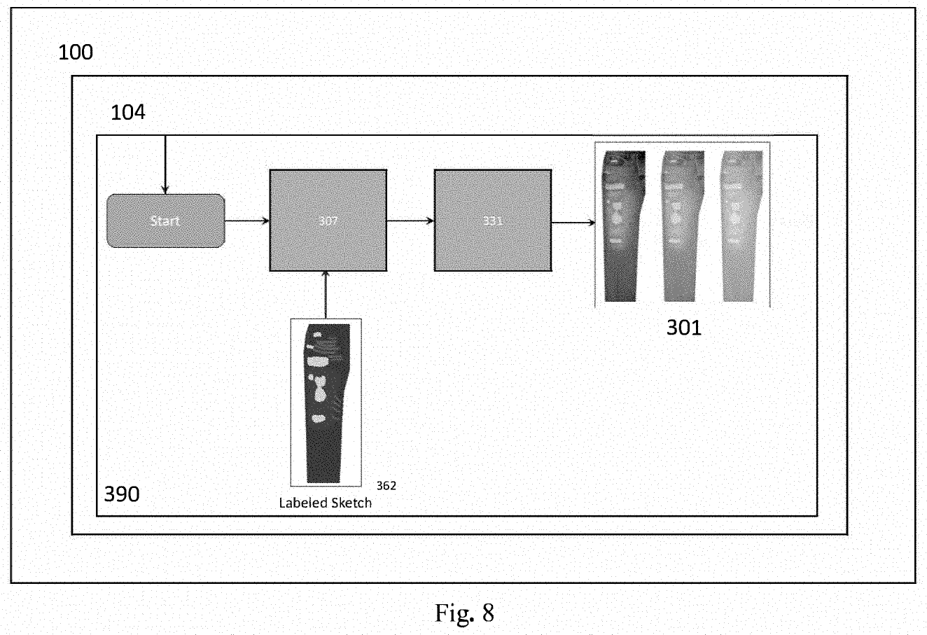

FIG. 9 shows a flowchart illustrating an embodiment method for creating patterns on garments 100. The method for creating patterns on garments 100, operating on a user device 104, involves garment processing logic 390. The garment processing logic 390 uses a designer input 307 of a reference image with region of interest 371 and a text description 373. Wherein designer input 307 can come from a variety of sources, in this embodiment, designer input 307, is limited to a reference image with region of interest 371 and a text description 373. As a result, the wear pattern generative model 331 then creates computer generated wear patterns 301 based on the reference image, region of interest, and text description 370.

At 307, the garment processing logic 390 receives the reference image with region of interest 371 and text description 373. In some implementations, the system 100 may analyze characteristics of the computer-generated wear pattern 301. In the present embodiment, the designer input takes the form of a reference image with region of interest 371 and text description 373. The user device 104 creates a score for computer-generated wear pattern 301, the score associated with a confidence that the computer-generated wear pattern 301 is a authentic and not computer generated. In some implementations, user device 104 may update the generative model based on the analysis of the computer-generated wear pattern 301 and based on the confidence score. In some embodiments, the score can be generated by a cloud-based data management system 102.

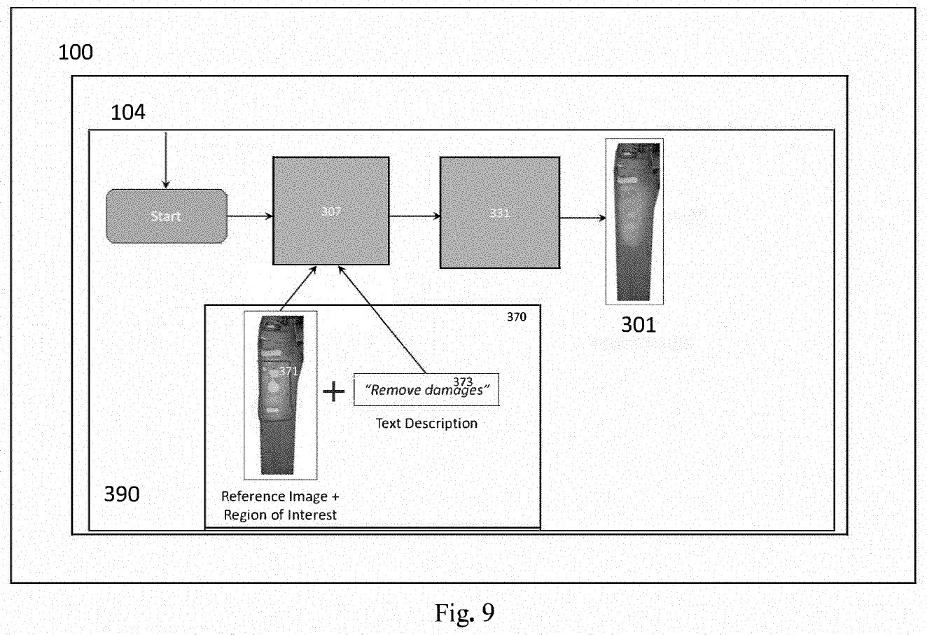

FIG. 10 shows a flowchart illustrating an embodiment method for creating patterns on garments 100. The method for creating patterns on garments 100, operating on a user device 104, involves garment processing logic 390. The garment processing logic 390 uses a designer input 307 of a combination 340 of non-computer-generated images. The combination 340 further contains a first non-computer-generated image 341 and a second non-computer-generated image 342.

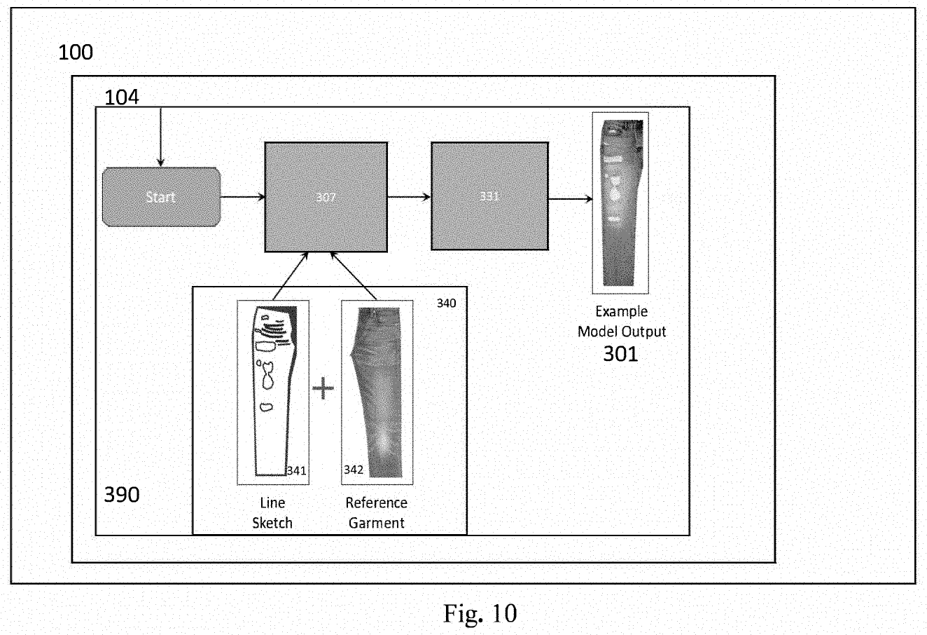

FIG. 11 illustrates an artificial neural network (ANN) 700, according to an implementation of the present disclosure. The ANN 700 may be used for, inter alia, classification or process control optimization according to various embodiments.

The ANN 700 may include any type of neural network module, such as, inter alia, a feedforward neural network, radial basis function network, recurrent neural network, or convolutional neural network.

In embodiments implementing the ANN 700 for entity classification, the ANN 700 may be employed to map entity data to entity classification data. In embodiments implementing the ANN 700 for process optimization, the ANN 700 may be employed to determine an optimal set or sequence of process control parameter settings for adaptive control of a process in real-time based on a stream of process monitoring data and/or entity classification data provided by, for example, observation or from one or more sensors. The ANN 700 may include an untrained ANN, a trained ANN, pre-trained ANN, a continuously updated ANN (e.g., an ANN utilizing training data that is continuously updated with real time classification data or process control and monitoring data from a single local system, from a plurality of local systems, or from a plurality of geographically distributed systems).

The ANN 700 may include interconnected nodes (e.g., x_1-x_i, x_1\hat{ }′-x_j\hat{ }′, and y_1-y_k) organized into n layers of nodes, where x_1-x_i represents a group of i nodes in a first layer 702 (e.g., layer 1), x_1\hat{ }′-x_j\hat{ }′ represents a group of j nodes in a hidden layer 703 (e.g., layer(s) 2 through n−1), and y_1-y_k represents a group of k nodes in a final layer 704 (e.g., layer n). The input layer 702 may be configured to receive input data 701 (e.g., sensor data, image data, sound data, observed data, automatically retrieved data, manually input data, etc.). The final layer 704 may be configured to provide result data 705.

There may be one or multiple hidden layers 703, and the number j of nodes in each hidden layer 703 may vary from embodiment to embodiment. Thus, the ANN 700 may include any total number of layers (e.g., any number of the hidden layers 703). One or more of the hidden layers 703 may function as trainable feature extractors, which may allow mapping of the input data 701 to the preferred result data 705.

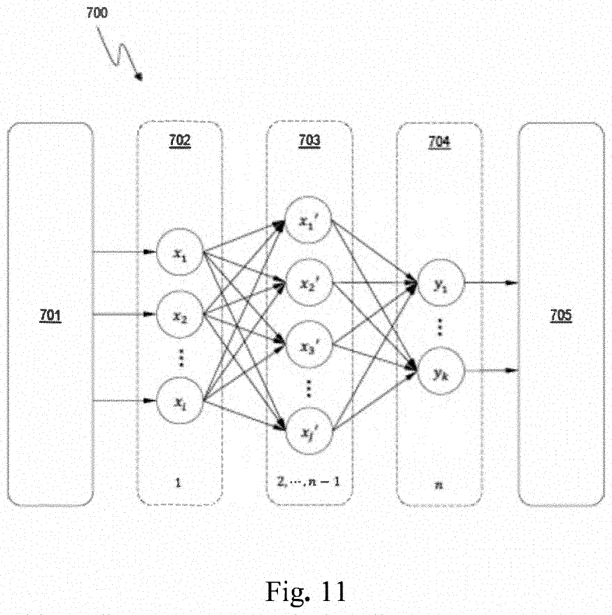

FIG. 12 illustrates neural network 800, according to an implementation of the present disclosure. Each layer of a neural network may include one or more nodes similar to the node 800, for example, nodes x_1-x_i, x_1\hat{ }′-x_j\hat{ }′, and y_1-y_k depicted in FIG. 7. Each node may be analogous to a biological neuron.

The node 800 may receive node inputs 801 (e.g., a_1-a_n) either directly from the ANN's input data (e.g., the input data 701) or from the output of one or more nodes in a different layer or the same layer. With the node inputs 801, the node may perform an operation 803, which while depicted in FIG. 8 as a summation operation, would be readily understood to include various other operations known in the art.

In some cases, the node inputs 801 may be associated with one or more weights 802 (e.g., w_1-w_n), which may represent weighting factors. For example, the operation 803 may sum the products of each of the node inputs 801 and the associated weights 802.

The result of operation 803 may be offset with a bias 804 (e.g., bias b), which may be a value or a function.

The output 806 of the node 800 may be gated using an activation (or threshold) function 805 (e.g., function f), which may be a linear or a non-linear function. The activation function 805 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

The weights 802, the biases 804, or threshold values of the activation functions 805, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

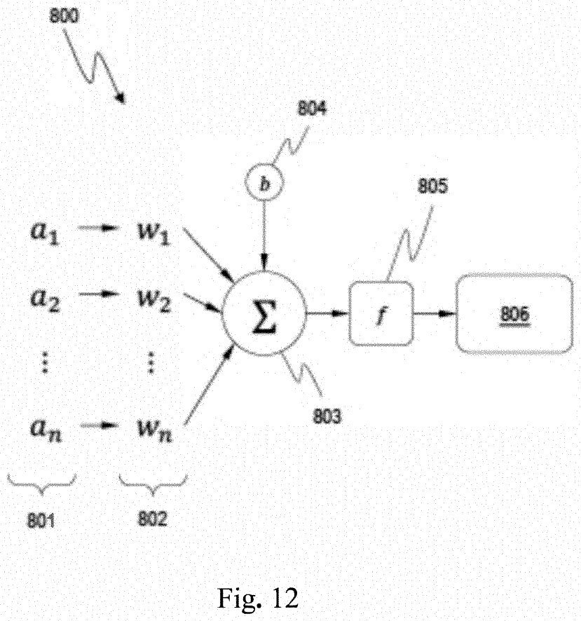

FIG. 13 illustrates a method 900 of training a machine learning model of a machine learning module, according to an implementation of the present disclosure. Use of method 900 may provide for use of training data to train a machine learning model for concurrent or later use.

At 901, a machine learning model including one or more machine learning algorithms may be provided.

At 902, training data may be provided. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. In some cases, the type of data included in the training data set may vary depending on the specific type of machine learning algorithm employed.

At 903, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

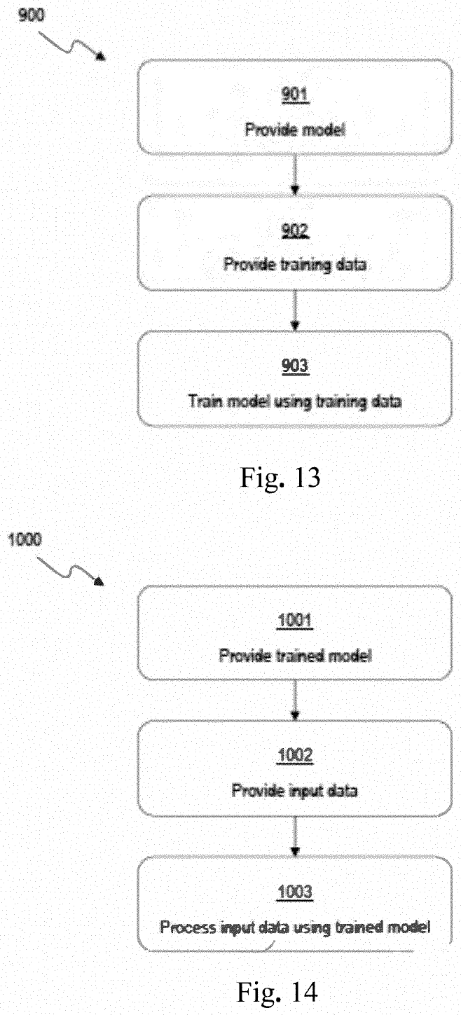

FIG. 14 illustrates a method 1000 of analyzing input data using a machine learning module, according to an implementation of the present disclosure. Use of the machine learning module described by method 1000 may enable, for example, automatic classification of an entity or optimized process control.

At 1001, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to the ANN 700, include nodes similar to the node 800, and may have been trained (or be under continuous or periodic training) using a method similar to the method 900.

At 1002, input data may be provided to the machine learning module for input into the machine learning model. The input data may result from or be derived from a variety of different sources, similar to the input data 701.

The provision of input data at 1002 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 1002 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 1003, the machine learning module may process the input data using the trained machine learning model to yield results from the machine learning module. Such results may include, for example, an entity classification or one or more optimized process control parameters.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a Fig., and where it is clear that the element is duplicated throughout the Fig., only one label may be provided for the element, despite multiple instances of the element being present in the Fig. Accordingly, other instances in the Fig. of the element having identical or similar structure and/or function may not have been redundantly labeled. A person having ordinary skill in the art will recognize based on the disclosure herein redundant and/or duplicated elements of the same Fig. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system comprising:
a memory storing an executable logic;
a processor executing the executable logic to:
train a design model on a relationship between non-computer-generated garment design information and non-computer-generated garment wear patterns;
receive a designer input;
generate a garment wear pattern based on the design model and the designer input; and
transmit the generated garment wear pattern for application to a garment.

2. The system of claim 1, further comprising a distressing machine for applying the generated garment wear pattern to a garment.

3. The system of claim 2, wherein the distressing machine includes at least one of a laser, an acid washing machine, a sand blasting machine, an enzyme washing machine, a water-jet fading machine, a sunlight fading machine, an over dye tinting machine, and an ozone fading machine.

4. The system of claim 1, wherein, to train the design model, the processor executes a training code to:
receive a non-computer-generated input;
receive a non-computer-generated garment design information;
learn a relationship between the designer input and the non-computer-generated garment design information;
generate a garment wear pattern based on the design model and a designer input;
determine, using the design model, that the generated garment wear pattern is one of a computer-generated wear pattern and a non-computer-generated wear pattern; and
adjust a network weight of a relationship between the non-computer-generated input and the non-computer-generated garment design information to produce a more realistic wear pattern.

5. The system of claim 1, wherein the designer input is a line drawing of a garment.

6. The system of claim 1, wherein the executable logic comprises an artificial neural network.

7. The system of claim 1, wherein the designer input comprises a design element overlayed on a region of the garment wear pattern.

8. The system of claim 1, wherein the design model is based on a generative adversarial network of a plurality of non-computer-generated wear patterns.

9. A method for execution by a system having a hardware processor, the method comprising:
training, using the hardware processor, a design model on a relationship between non-computer-generated garment design information and non-computer-generated garment wear patterns;
receiving, using the hardware processor, a designer input;
generating, using the hardware processor, a garment wear pattern based on the design model and the designer input; and
transmitting, using the hardware processor, the generated garment wear pattern for application to a garment.

10. The method of claim 9, further comprising applying the generated garment wear pattern to a garment using a distressing machine.

11. The method of claim 10, wherein the distressing machine includes at least one of a laser, an acid washing machine, a sand blasting machine, an enzyme washing machine, a water-jet fading machine, a sunlight fading machine, an over dye tinting machine, and an ozone fading machine.

12. The method of claim 9, wherein, to train the design model, method further comprises:
receiving, using the hardware processor, a non-computer-generated input;
receiving, using the hardware processor, a non-computer-generated garment design information;
learning, using the hardware processor, a relationship between the designer input and the non-computer-generated garment design information;
generating, using the hardware processor, a garment wear pattern based on the design model and a designer input;
determine, using the design model, that the generated garment wear pattern is one of a computer-generated wear pattern and a non-computer-generated wear pattern; and
adjusting, using the hardware processor, a network weight of a relationship between the non-computer-generated input and the based on the non-computer-generated garment design information to produce a more realistic wear pattern.

13. The method of claim 9, wherein the designer input is a line drawing of a garment.

14. The method of claim 9, wherein the design model comprises an artificial neural network.

15. The method of claim 9, wherein the designer input comprises a design element overlayed on a region of the garment wear pattern.

16. The method of claim 9, wherein the design model is based on a generative adversarial network of a plurality of non-computer-generated wear patterns.

17. A system, comprising:
a user device with a processing device configured to generate a wear pattern for a garment, where in the user device comprises:
a memory device configured to:
store a first non-computer-generated wear pattern that utilize reorientations of a first garment with a wear pattern; and
store a second computer-generated wear pattern that comprise a second garment with stylized distress pattern comprising a style element; and
the processing device configured to execute a generative model that integrates the first non-computer-generated wear pattern or the second non-computer-generated wear pattern to create a computer-generated wear pattern;
a server configured to execute an artificial neural network program generated from an analysis of a database of distressed garments, wherein:
the artificial neural network program is trained to identify, from the first non-computer-generated wear pattern or the second non-computer-generated wear pattern, elements of a distressed garment; and
the artificial neural network program is configured to generate a machine-readable algorithm based on a prioritization of the distressed garment.

18. The system of claim 16, further comprising a distressing machine comprising a distressor device configured to reproduce a distressed wear pattern on a new garment based on a distressing instruction received from the server executing the machine-readable algorithm.

19. The system of claim 16, wherein the generative model produces a distressing file for a distressing machine.

20. The system of claim 16, wherein the non-computer-generated wear pattern is a text description of a portion of the garment.
